(19) United States
(12) Patent Application Publication
(10) Pub. No.: US 2026/0302352 A1
(43) Pub. Date: Oct. 1, 2026

(54) LITHIUM-ION SECONDARY BATTERY

(71) Applicant: ZHUHAI COSMX BATTERY CO., LTD., Zhuhai (CN)

(72) Inventors: Guanglin Liang, Zhuhai (CN); Jialin Fang, Zhuhai (CN)

(21) Appl. No.: 19/570,189

(22) Filed: Mar. 18, 2026

(30) Foreign Application Priority Data
Mar. 27, 2025 (CN) 202510376216.6

(51) Int. Cl. H01M 10/0567; H01M 4/02; H01M 4/133; H01M 4/134; H01M 4/36; H01M 4/38; H01M 4/587; H01M 10/0525; H01M 10/0568; H01M 10/0569; H01M 10/0587; H01M 50/533; H01M 50/536

(52) U.S. Cl. CPC H01M 10/0567; H01M 4/133; H01M 4/134; H01M 4/364; H01M 4/386; H01M 4/587; H01M 10/0525; H01M 10/0568; H01M 10/0569; H01M 10/0587; H01M 50/533; H01M 50/536; H01M 2004/027; H01M 2300/0037

(57) ABSTRACT

A lithium-ion secondary battery comprises a jelly roll formed by laminating and winding a positive electrode plate, a separator, and a negative electrode plate. The negative electrode plate comprises a silicon-based material. The jelly roll has an arcuate region and a straight region connected to the arcuate region. The radius R of the arcuate region and the thickness T of the jelly roll satisfy:

$$0.9 \leq \frac{2 R}{T} \leq \frac{4}{π} .$$

The lithium-ion secondary battery further comprises an electrolyte, and the electrolyte comprises fluoroethylene carbonate and 1,3-propane sultone. The mass content c1 of fluoroethylene carbonate in the electrolyte is 4%-20%, and the mass content c2 of 1,3-propane sultone in the electrolyte is 1%-5%. The battery of the present disclosure can effectively improve the problems of cracking and lithium plating in the arcuate region.

### CROSS-REFERENCE TO RELATED APPLICATIONS

The present application claims priority to Chinese Patent Application No. 202510376216.6, titled “LITHIUM-ION SECONDARY BATTERY,” filed on Mar. 27, 2025, the entire contents of which are incorporated herein by reference.

### TECHNICAL FIELD

The present disclosure relates to the technical field of batteries, in particular to a lithium-ion secondary battery.

### BACKGROUND ART

With the rise of green energy, the technological development of lithium batteries is very important. Lithium-ion batteries are the most widely used batteries in portable electronic products, electric vehicles, power tools and various power grid applications because of their high power, high energy density, low cost and long life cycle. In order to meet the fast-growing range needs of electronics and electric vehicle industries, researchers usually choose to add silicon-based materials with higher specific capacity in order to produce lithium-ion batteries with high volumetric energy density. However, with the increase of the content of silicon-based materials, the interface failure of the batteries during cycling has become a challenge in the research of lithium-ion batteries. Especially for the wound battery, there will be the problems of cracking and lithium plating at the arcuate region during cycling, which will seriously affect the cycle life and safety of lithium-ion batteries.

### SUMMARY

An object of the present disclosure is to provide a lithium-ion secondary battery in order to overcome the problems of cracking and lithium plating at the arcuate region during cycling of the silicon-doped wound batteries in the prior art. The lithium-ion secondary battery (hereinafter referred as battery) of the present disclosure can improve the problem of cracking caused by stress concentration at the arcuate region of the silicon-doped wound battery by adjusting and controlling the relationship between the radius of the arcuate region and the thickness of the jelly roll. At the same time, by adding fluoroethylene carbonate (FEC) and 1,3-propane sultone (PS) into the electrolyte, and adjusting and controlling their mass contents in the electrolyte, the problem of lithium plating at the arcuate region is improved, and the problem of cracking at the arcuate region is further improved.

In the related art, the silicon-doped wound batteries will suffer the problems of cracking and lithium plating at the arcuate region during cycling. Through research, the inventors of the present disclosure have found that the reason for the above problems is that the structural feature of the arcuate region causes the volume of the arcuate region to be compressed, resulting in stress concentration. In addition, the silicon-based material has a large volume expansion during charging of the battery, which will further cause the volume of the arcuate region to be severely compressed, resulting in a series of interface problems at the arcuate region.

Based on the above findings, the inventors of the present disclosure adjust and control the relationship between the radius of the arcuate region and the thickness of the jelly roll by increasing the thickness of the arcuate region, so as to improve the problem of cracking at the arcuate region. This is because in the related art, the stress concentration at the arcuate region of the battery caused by winding tension during winding can not be effectively released. At this time, the radius R of the arcuate region and the thickness T of the jelly roll satisfy the following relationship:

$$0.75 \leq \frac{2 R}{T} < 0.9 .$$

At this time, the following problems will arise. Firstly, the stress concentration at the arcuate region will squeeze the positive electrode current collector located in the arcuate region and easily lead to the cracking of the positive electrode current collector. Secondly, the stress concentration at the arcuate region will squeeze the electrolyte out of the arcuate region, resulting in insufficient electrolyte infiltration at the arcuate region, which will lead to lithium plating at the arcuate region. Thirdly, the electrolyte in the arcuate region is squeezed out to the straight region, resulting in a concentration difference of the electrolyte between the arcuate region and the straight region. The electrolyte concentration at the arcuate region is lower than that at the straight region, causing a higher potential in the arcuate region and a lower potential in the straight region, which leads to the corrosion of the negative electrode current collector located in the arcuate region due to the larger potential difference, thus causing the damage of the negative electrode current collector. On the contrary, when the radius R of the arcuate region and the thickness T of the jelly roll satisfy

$$0.9 \leq \frac{2 R}{T} \leq \frac{4}{π} ,$$

the arcuate region has a certain stress release space, which can alleviate the stress concentration at the arcuate region and reduce the concentration difference of the electrolyte between the arcuate region and the straight region. In addition, the stress release space is not too large to affect electrical contact within the battery.

However, if only the relationship between the radius R of the arcuate region and the thickness T of the jelly roll is adjusted and controlled, a significant improvement for the problem of lithium plating at the arcuate region can not achieved. Through a number of targeted studies, the inventors of the present disclosure found that by further adding FEC and PS in the electrolyte and adjusting and controlling their mass contents in the electrolyte, the problem of lithium plating at the arcuate region can be significantly improved and the problem of cracking can be further improved. The reasons are as follows.

Firstly, FEC, as an efficient film-forming additive, can be preferentially reductively decomposed on the surface of the negative electrode to form a LiF-rich SEI (Solid Electrolyte Interphase) film, and LiF has a high mechanical strength, low electron conductivity and high lithium ion diffusion ability, which can effectively suppress the growth of lithium dendrites and improve the homogeneity of the SEI film. Moreover, the sulfonic group of PS can also participate in the formation of SEI film, thus enhancing the flexibility and self-repairing ability of the film. The lactone structure of PS can also suppress the oxidation side reaction of the electrolyte, reduce gas generation and maintain the interface stability. The combined use of the two enables the formation of an SEI film with both mechanical strength and elasticity and can alleviate the local lithium plating caused by the rupture of the SEI film especially at the stress-concentrated arcuate region. Especially when the negative electrode plate comprise a silicon-based material, the stress concentration at the arcuate region is more obvious. The addition of FEC and PS can significantly improve the problem of lithium plating caused by the rupture of the SEI film due to the stress concentration. Secondly, the sulfonic group of PS has a strong polarity, which can improve the infiltration of the electrolyte to the electrode plate (especially at the arcuate region), reduce the contact impedance of the electrode plate/electrolyte interface, and promote the uniform distribution of lithium ions. The combined use of FEC with a low relative viscosity and PS can balance the viscosity of the electrolyte and ion conductivity, avoid the obstruction of ion migration caused by excessive addition, and thus reduce local polarization. Thirdly, the thickness, compactness and ion transport kinetics of the SEI film can be adjusted by adjusting and controlling the content of both, so that an SEI film with elasticity and adaptability to deformation can be obtained, cracking of the SEI film due to stress concentration can be prevented, and interface uniformity can be maintained. However, if the addition of FEC and/or PS is excessive, the corrosion on the negative electrode current collector caused by the potential difference in the arcuate region and the straight region will be aggravated, and the strength of the corroded negative electrode current collector will be significantly reduced, which will prone to fragmentation and cracking, posing a safety risk. Moreover, if the addition of FEC and PS is insufficient, the protection of the interface film on the negative electrode will be affected, which will lead to lithium plating and affect the cycling stability of the battery.

Therefore, there is a need to control the mass contents of FEC and PS in the electrolyte, where the size of the arcuate region can be effectively matched with the electrolyte, which can not only allow the electrolyte to provide effective protection for the negative electrode, but also avoid excessive FEC and PS, thus preventing the negative electrode current collector from damage. Such way is helpful to improve the problems of cracking and lithium plating at the arcuate region, and improve the cycling stability and safety performance of the battery. Based on this, the inventors of the present disclosure propose the following solutions:
a lithium-ion secondary battery, the lithium-ion secondary battery comprises a jelly roll formed by laminating and winding a positive electrode plate, a separator, and a negative electrode plate, wherein the negative electrode plate comprises a silicon-based material; the jelly roll has an arcuate region and a straight region connected to the arcuate region; and the radius R of the arcuate region and the thickness T of the jelly roll satisfy:

$$0.9 \leq \frac{2 R}{T} \leq \frac{4}{π} ,$$

where π is the ratio of circumference to diameter; and wherein the lithium-ion secondary battery further comprises an electrolyte, and the electrolyte comprises fluoroethylene carbonate and 1,3-propane sultone; the mass content c1 of fluoroethylene carbonate in the electrolyte is 4%-20%, and the mass content c2 of 1,3-propane sultone in the electrolyte is 1%-5%.

By means of the above technical solution, the present disclosure has at least the following advantages over the prior art:
(1) the battery of the present disclosure can improve the problem of lithium plating at the arcuate region, thereby improving the thickness increase in the arcuate region caused by lithium plating;
(2) the battery of the present disclosure can improve the problem of the cracking of the positive electrode current collector in the arcuate region;
(3) the battery of the present disclosure can improve the problem of the cracking of the negative electrode current collector in the arcuate region; and
(4) the battery of the present disclosure has a good cycling stability.

The endpoints of ranges and any values disclosed herein are not limited to such exact ranges or values, and these ranges or values should be understood to include values close to these ranges or values. For numerical value ranges, one or more new numerical value ranges can be obtained between endpoint values of various ranges, between endpoint values of various ranges and individual point values, and between individual point values, and these numerical value ranges should be regarded as specifically disclosed herein.

### BRIEF DESCRIPTION OF THE DRAWINGS

FIG. 1 is a schematic view of the structure of a jelly roll in an example of the present disclosure.

FIG. 2 is a partial schematic view of a jelly roll in an example of the present disclosure.

FIG. 3 is a cross-sectional schematic view of a jelly roll in an example of the present disclosure.

### DETAILED DESCRIPTION OF EMBODIMENTS

Hereinafter, specific embodiments of the present disclosure will be described in detail. It should be understood that the specific embodiments described herein are only used to illustrate and explain the present disclosure and are not used to limit the present disclosure.

The present disclosure provides a lithium-ion secondary battery. The lithium-ion secondary battery may comprise a jelly roll formed by laminating and winding a positive electrode plate, a separator, and a negative electrode plate. The negative electrode plate may comprise a silicon-based material. The jelly roll has an arcuate region and a straight region connected to the arcuate region; and the radius R of the arcuate region and the thickness T of the jelly roll satisfy:

$$0.9 \leq \frac{2 R}{T} \leq \frac{4}{π} ,$$

where π is the ratio of circumference to diameter, for example 0.9, 1, 1.1, 1.2 or 4/π.

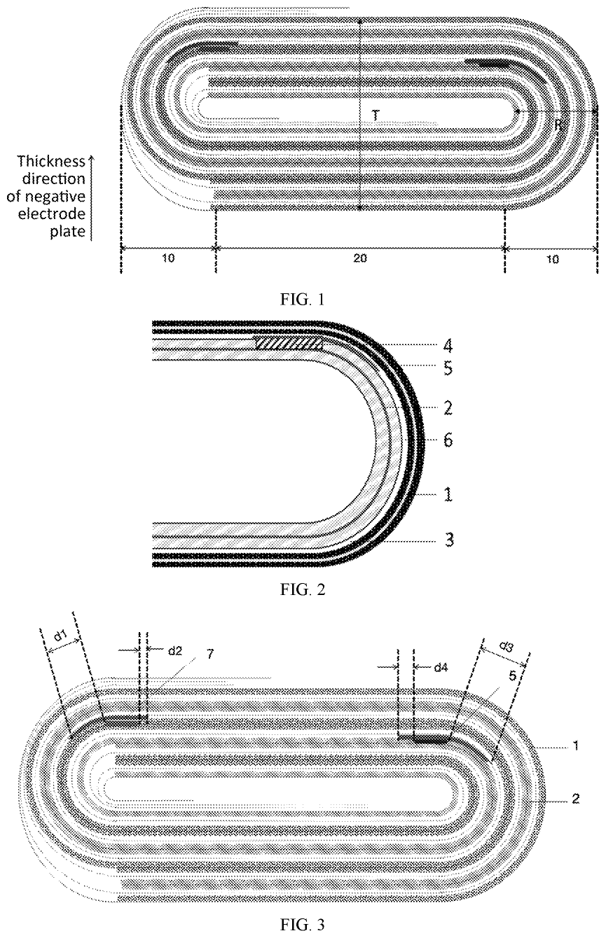

In the present disclosure, the radius R of the arcuate regions and the thickness T of the jelly roll have conventional meanings in the art. FIG. 1 is a schematic view of the structure of a jelly roll in an example of the present disclosure. As can be seen from the figure, the jelly roll has an arcuate region 10 and a straight region 20 connected to the arcuate region 10. The thickness T of the jelly roll refers to the size of the central portion of the jelly roll in the thickness direction of the negative electrode plate. The radius R of the arcuate region refers to the shortest distance from the outermost side of the arcuate region to the innermost side of the arcuate region in the direction perpendicular to the thickness direction of the jelly roll.

In the present disclosure, the lithium-ion secondary battery may further comprise an electrolyte. The electrolyte may comprise fluoroethylene carbonate and 1,3-propane sultone. The mass content c1 of fluoroethylene carbonate in the electrolyte may be 4%-20%, for example 4%, 5%, 10%, 15% or 20%. The mass content c2 of 1,3-propane sultone in the electrolyte may be 1%-5%, for example 1%, 2%, 3%, 4% or 5%.

In the present disclosure, c1 and c2 can be determined by means of a conventional test method in the art, for example gas chromatography (GC) or gas chromatography-mass spectrometer (GCMS).

In the present disclosure, the mass content c1 of fluoroethylene carbonate in the electrolyte, the mass content c2 of 1,3-propane sultone in the electrolyte, R and T satisfy:

$$4 \leq \frac{2 R}{T \times ( c 1 + c 2 )} \leq 17 ,$$

for example 4, 5, 6, 7, 8, 9, 10, 11, 12, 13, 14, 15, 16 or 17.

In an embodiment,

$$5.8 \leq \frac{2 R}{T \times ( c 1 + c 2 )} \leq 8.7 .$$

In an embodiment,

$$6.6 \leq \frac{2 R}{T \times ( c 1 + c 2 )} \leq 7.7 .$$

As mentioned above, the combined use of FEC and PS can form a stable and tough interface film on the surface of the negative electrode. Especially when the negative electrode plate comprises a silicon-based material, the stress concentration issue at the arcuate region of the jelly roll is more serious, and these two materials need to be added to form a more stable and tough SEI film, thus solving the problem of lithium plating caused by the rupture of the SEI film due to stress concentration. When the radius R of the arcuate region and the thickness T of the jelly roll satisfy a specific relationship, the smaller the ratio of 2R to T, the greater the concentration difference of the electrolyte between the arcuate region and the straight region. At this time, there is a need to reduce the contents of FEC and PS to alleviate the corrosion of the negative electrode current collector and the lithium plating at the arcuate region caused by excessively high concentration difference. On the contrary, the greater the ratio of 2R to T, the smaller the concentration difference of the electrolyte between the arcuate region and the straight region. At this time, the contents of FEC and PS can be appropriately increased, which can improve the quality and regeneration ability of the interface film on the surface of the negative electrode without causing corrosion to the negative electrode current collector, thus improving the cycling stability of the battery.

In the present disclosure, the radius R of the arcuate region may be 1-15 mm, for example 1 mm, 2 mm, 3 mm, 4 mm, 5 mm, 6 mm, 7 mm, 8 mm, 9 mm, 10 mm, 11 mm, 12 mm, 13 mm, 14 mm or 15 mm. The thickness T of the jelly roll may be 2-30 mm, for example 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm or 30 mm.

In the present disclosure, c1/c2 may be 1-12, for example 1, 2, 3, 4, 5, 6, 7, 8, 9, 10, 11 or 12.

In an embodiment, c1/c2 is 3-8.

Although both FEC and PS are film-forming additives for a negative electrode, their film-forming mechanisms are different. Therefore, the addition of both FEC and PS is beneficial to improve the uniformity and mechanical strength of the interface film on the surface of the negative electrode. FEC has a poor high temperature stability. Therefore, excessive FEC is not beneficial to the high temperature cycling performance of the battery. However, PS has a good high temperature stability. Therefore, the combined use of FEC and PS and the adjustment and control of the ratio of their mass contents in the electrolyte can improve the cycling stability of the battery without adversely affecting the high temperature performance of the battery.

In the present disclosure, the electrolyte may further comprise a lithium salt. The lithium salt may include lithium salts conventionally used in the art, for example at least one of lithium hexafluorophosphate (LiPF₆), lithium tetrafluoroborate (LiBF₄), lithium perchlorate (LiClO₄), lithium bisfluorosulfonimide (LiFSI), lithium bis(trifluoromethanesulfonimide) (LiTFSI), lithium trifluoromethanesulfonate (LiTFS), lithium difluorooxalatoborate (LiDFOB), lithium difluorophosphate (LiPO₂F₂), lithium bisoxalatodifluorophosphate (LiDFOP), lithium tetrafluorooxalatophosphate (LiTFOP) and lithium bis(oxalato) borate (LiBOB).

In the present disclosure, the mass content c3 of the lithium salt in the electrolyte, R and T satisfy:

$$0.07 \leq \frac{2 R}{T} \times c 3 \leq 0.25 ,$$

for example 0.07, 0.08, 0.09, 0.1, 0.11, 0.12, 0.13, 0.14, 0.15, 0.16, 0.17, 0.18, 0.19, 0.2, 0.21, 0.22, 0.23, 0.24 or 0.25.

In an embodiment,

$$0.095 \leq \frac{2 R}{T} \times c 3 \leq 0.2 .$$

In an embodiment,

$$0.095 \leq \frac{2 R}{T} \times c 3 \leq 0.17 .$$

When the radius R of the arcuate region and the thickness T of the jelly roll satisfy a specific relationship, the problem of lithium plating at the arcuate region can be further improved by adjusting and controlling the relationship among R, T and the mass content of the lithium salt. The reason lies in that the lithium salt plays a crucial role in the transport of lithium ions. When the stress in the arcuate region is constant, the greater the mass content of the lithium salt in the electrolyte, the greater the mass of the lithium salt in the arcuate region. At this time, the faster the transport of lithium ions at the arcuate region, and the less prone lithium plating occurs. Therefore, when the radius R of the arcuate region and the thickness T of the jelly roll satisfy a specific relationship, the smaller the ratio of 2R to T, the more concentrated the stress in the arcuate region. At this time, there is a need to increase the content of the lithium salt to improve the problem of lithium plating. On the contrary, the greater the ratio of 2R to T, the smaller the stress in the arcuate region, and the less the lithium salt is required. Therefore, there is a need to adjust and control the relationship among R, T and the mass content of the lithium salt, which is beneficial to further improve the problem of lithium plating at the arcuate region and can give full play to the electrical performance of the battery.

In the present disclosure, c3 may be 7%-25%, for example 7%, 10%, 15%, 20% or 25%.

In an embodiment, c3 is 10%-15%.

In the present disclosure, the mass content c3 of the lithium salt in the electrolyte can be determined by means of a conventional test method in the art, for example ion chromatography (IC).

In the present disclosure, the viscosity V of the electrolyte, R and T satisfy:

$$0.1 \leq \frac{2 R}{T \times V} \leq 0.4 ,$$

for example 0.1, 0.15, 0.2, 0.25, 0.3, 0.35 or 0.4.

In an embodiment,

$$0.16 \leq \frac{2 R}{T \times V} \leq 0.26 .$$

The viscosity of the electrolyte is related to the problems of lithium plating and cracking at the arcuate region. Moreover, the contents of FEC and PS in the electrolyte also have a large influence on the viscosity of the electrolyte. The greater the viscosity of the electrolyte, the more unfavorable it is to the infiltration of the arcuate region, and the more likely it is to cause the problems of lithium plating and cracking. However, the viscosity of the electrolyte should not be too small. The electrolyte with too small viscosity means that the contents of the lithium salt and additives are low, and the overall stability of the electrolyte is poor, which is not beneficial to the overall electrical performance of the battery. Therefore, it is necessary to adjust the viscosity of the electrolyte according to the radius of the arcuate region and the thickness of the jelly roll, so that the two can be matched each other, thus improving the overall electrical performance of the battery and further improving the problems of lithium plating and cracking at the arcuate region.

In the present disclosure, the viscosity V of the electrolyte may be 3-10 Pa·s, for example 3, 4, 5, 6, 7, 8, 9 or 10 Pa· s.

In the present disclosure, the viscosity V of the electrolyte can be determined by means of a conventional test method in the art, for example a method as follows. The lithium-ion secondary battery is discharged to 0% SOC, placed in a centrifuge and centrifuged at 5000 r/min for 30 min. The battery is placed in a hydraulic press and compressed at 0.5 MPa, and the electrolyte is taken as a sample. At an ambient temperature of 25° C., the sample is injected into a test container, which is placed in a metal contact piece below a viscometer, and the viscometer is turned on and then reading is made.

In the present disclosure, the electrolyte may further comprise an organic solvent. The organic solvent may include a carbonate solvent and/or a carboxylate solvent. The carbonate solvent may include a cyclic carbonate solvent and/or a linear carbonate solvent. The cyclic carbonate solvent may include cyclic carbonates conventionally used in the art, for example at least one of ethylene carbonate (EC), propylene carbonate (PC) and butylene carbonate (BC). The linear carbonate solvent may include linear carbonates conventionally used in the art, for example at least one of dimethyl carbonate (DMC), diethyl carbonate (DEC), dipropyl carbonate (DPC), methyl ethyl carbonate (EMC), methyl propyl carbonate (MPC) and ethyl propyl carbonate (EPC). The carboxylate solvent may include carboxylates conventionally used in the art, for example at least one of methyl formate (MF), methyl acetate (MA), ethyl acetate (EA), propyl acetate (PA), methyl propionate (MP), ethyl propionate (EP), propyl propionate (PP), methyl butyrate (MB) and ethyl butyrate (EB).

In the present disclosure, the mass content c4 of the carbonate solvent in the electrolyte may be 10%-70%, for example 10%, 20%, 30%, 40%, 50%, 60% or 70%. The mass content c5 of the carboxylate solvent in the electrolyte may be 3%-40%, for example 3%, 4%, 5%, 6%, 7%, 8%, 9%, 10%, 15%, 20%, 25%, 30%, 35% or 40%.

The carbonate solvents have a high dielectric constant and are usually used to dissociate the lithium salt, but they have a high viscosity and poor infiltration. However, the carboxylate solvents have a low viscosity and can adjust the viscosity and conductivity of the electrolyte. Therefore, when the mass contents of the carbonate solvent and the carboxylate solvent are within a specific range, the viscosity of the electrolyte can be effectively adjusted and the conductivity of the electrolyte can be improved. When the content of the carbonate solvent in the electrolyte is small (for example, less than 10%), the strength of the SEI film may be insufficient, which can lead to the decomposition of the electrolyte and the decline of cycling performance of battery. On the contrary, when the content of the carbonate in the electrolyte is large (for example, more than 70%), the viscosity of the electrolyte may be too large, which can affect the infiltration of the electrolyte to the arcuate region, and then lead to the deterioration of the interface. When the content of the carboxylate solvent in the electrolyte is small (for example, less than 3%), the infiltration of the electrolyte to the arcuate region and the low temperature stability will be decreased, which is not beneficial to the cycling of the battery. On the contrary, when the content of the carboxylate solvent in the electrolyte is large (for example, more than 40%), the risk of thermal runaway of the battery at high temperature will increase. Moreover, when the content of the carboxylate solvent in the electrolyte is too large, the overall thermal safety performance of the battery will be reduced. This is because the carboxylate solvent has a relatively low boiling point, the high temperature stability thereof is poor and is prone to decompose at a high temperature, resulting in more gas generation inside the battery. However, the battery structure of the present disclosure can effectively improve the above problems, the reasons are as follows. According to the present disclosure, the radius R of the arcuate region and the thickness T of the jelly roll satisfy a specific relationship by adjusting the positions of the tabs (including the positive electrode tab and the negative electrode tab). Such arrangement can not only allow the arcuate region to have a certain stress release space, but also allow the positions of the tabs to close to the arcuate region (the shortest distance from the edge of the positive electrode tab to the edge of the arcuate region is 0-6 mm; and the shortest distance from the edge of the negative electrode tab to the edge of the arcuate region is 0-6 mm, as described hereinafter). Thermal runaway usually occurs because the temperature of the tab is too high. Therefore, by allowing the positions of the tabs to close to the arcuate region, when the temperature of the tab increases, the gas generated around the tab will increase, and the generated gas can first enter the stress release space in the arcuate region, thus alleviating the pressure increase caused by gas generation inside the battery. With the increase of gas generation, when the amount of gas stored in the arcuate region reaches a certain level, the gas is preferentially discharged from the battery at the arcuate region. Therefore, the battery structure of the present disclosure is also beneficial to the discharge of gas inside the battery, and can improve the problem of poor thermal safety performance caused by excessive carboxylate solvents in the battery.

In the present disclosure, the mass content c4 of the carbonate solvent in the electrolyte and the mass content c5 of the carboxylate solvent in the electrolyte can be determined by means of a conventional test method in the art, for example GC or GCMS.

In the present disclosure, the organic solvent may further include at least one of 1,4-butyrolactone (GBL), sulfolane (SF), dimethyl sulfone (MSM), methyl ethyl sulfone (EMS) and diethyl sulfone (ESE).

In the present disclosure, the electrolyte may further comprise an additive and/or a diluent. The additive includes, for example, at least one of vinylene carbonate (VC), vinyl ethylene carbonate (VEC), ethylene sulfate (DTD), propylene sulfate, ethylene sulfite (ES), 1,3-propene sulfolactone (PST), cyclic quaternary ammonium sulfonate, succinic anhydride, succinonitrile (SN), adiponitrile (AND), 1,3,6-hexanitrile (HTCN), tris(trimethylsilane) phosphate (TMSP) and tris(trimethylsilane) borate (TMSB). The diluent includes, for example, at least one of 1,1,2,2-tetrafluoroethyl-2,2,3,3-tetrafluoropropyl ether (TTE), 1,1,2,2-tetrafluoroethyl-2,2,3,3-tetrafluoropropyl ether (HFE) and triethylene glycol dimethyl ether (TEP).

In the present disclosure, the positive electrode plate may comprise a positive electrode tab located in a positive electrode tab welding zone and a first adhesive tape covering the positive electrode tab welding zone. The negative electrode plate may comprise a negative electrode tab located in a negative electrode tab welding zone and a second adhesive tape covering the negative electrode tab welding zone. The first adhesive tape covers at least portion of the arcuate region, and the second adhesive tape covers at least portion of the arcuate region.

By adjusting the positions of the positive and negative electrode tabs, the first and second adhesive tapes can cover portion of the arcuate region, so that the adhesive tape (the first and second adhesive tapes) can effectively support the arcuate region, and the stress release space in the arcuate region is increased. FIG. 2 is a partial schematic view of a jelly roll in an example of the present disclosure. As can be seen from the figure, the jelly roll is formed by winding a positive electrode plate 1, a separator 3, and a negative electrode plate 2, wherein the negative electrode plate 2 comprises a negative electrode tab 4 located in a negative electrode tab welding zone and a second adhesive tape 5 covering the negative electrode tab welding zone. According to the present disclosure, by adjusting the position of the negative electrode tab 4 (in the related art, the tab of the battery is not close to the arcuate region), the negative electrode tab 4 is close to the arcuate region, so that the second adhesive tape 5 can play a supporting role in the arcuate region and a stress release space 6 is formed.

In the present disclosure, the size of the portion of the arcuate region covered by the first adhesive tape is 10%-50% of the arc length of the arc, for example 10%, 20%, 30%, 40% or 50%. The size of the portion of the arcuate region covered by the second adhesive tape is 10%-50% of the arc length of the arc, for example 10%, 20%, 30%, 40% or 50%.

In an embodiment, the size of the portion of the arcuate region covered by the first adhesive tape is 20%-40% of the arc length of the arc. The size of the portion of the arcuate region covered by the second adhesive tape is 20%-40% of the arc length of the arc.

In the present disclosure, the negative electrode plate may comprise a negative electrode current collector and a negative electrode active coating layer on a surface of at least one side of the negative electrode current collector. The negative electrode active coating layer may comprise the silicon-based material and a carbon-based material. The content c of elemental silicon in the negative electrode active coating layer and the thickness h1 (in μm) of the first adhesive tape satisfy: 6×10⁻⁴≤c/h1≤2×10⁻², for example 6×10⁻⁴, 7×10⁻⁴, 8×10⁻⁴, 9×10⁻⁴, 1×10⁻³, 2×10⁻³, 3×10⁻³, 4×10⁻³, 5×10⁻³, 6×10⁻³, 7×10⁻³, 8×10⁻³, 9×10⁻³, 1×10⁻² or 2×10⁻².

In an embodiment, 2×10⁻³≤c/h1≤4×10⁻³.

In an embodiment, 2.8×10⁻³≤c/h1≤3.8×10⁻³

In the present disclosure, the content c of elemental silicon in the negative electrode active coating layer and the thickness h2 (in μm) of the second adhesive tape satisfy: 6×10⁻⁴≤ c/h2≤2×10⁻², for example 6×10⁻⁴, 7×10⁻⁴, 8×10⁻⁴, 9×10⁻⁴, 1×10⁻³, 2×10⁻³, 3×10⁻³, 4×10⁻³, 5×10⁻³, 6×10⁻³, 7×10⁻³, 8×10⁻³, 9×10⁻³, 1×10⁻² or 2×10⁻².

In an embodiment, 2×10⁻³≤c/h2≤4×10⁻³.

In an embodiment, 2.8×10⁻³≤c/h2≤3.8×10⁻³.

The greater the content c of elemental silicon in the negative electrode active coating layer, the greater the volume expansion of the battery during the charging and discharging cycles, and the greater the stress on the arcuate region, so more stress release space is needed. However, the thickness of the first and second adhesive tapes is related to the stress release space in the arcuate region. When the thickness of the first and second adhesive tapes is thicker, the stress release space is larger. Of course, the thickness of the first and second adhesive tapes is not always advantageous if increased excessively. Excessive thickness will not only reduce the volumetric energy density, but also affect the electrical connection of the battery, thus affecting the overall electrical performance of the battery. Therefore, there is a need to define the relationship between the content of elemental silicon in the negative electrode active coating layer and the thickness of the adhesive tapes (including the first and second adhesive tape). When the two satisfy a specific relationship, the problems of lithium plating and cracking at the arcuate region of the battery can be improved with a little influence on the volumetric energy density and electrical performance of the battery.

In the present disclosure, c may be 1%-50%, for example 1%, 5%, 10%, 15%, 20%, 25%, 30%, 35%, 40%, 45% or 50%.

In the present disclosure, the content c of elemental silicon in the negative electrode active coating layer can be determined by means of a conventional test method in the art, for example energy dispersive spectrometer (EDS).

In the present disclosure, the silicon-based material includes at least one of elemental silicon, a silicon-oxygen material, a silicon-carbon material and a silicon alloy. The silicon-oxygen material refers to a composite containing elemental silicon and elemental oxygen, such as silicon oxides. The silicon-carbon material refers to a composite containing elemental silicon and elemental carbon, for example a silicon-carbon material comprising a porous carbon matrix and a silicon material located within internal pores of the porous carbon matrix.

In the present disclosure, the mass content of elemental silicon in the silicon-carbon material is 20%-70%, for example 20%, 30%, 40%, 50%, 60%, 65% or 70%.

In the present disclosure, the mass content of elemental silicon in the silicon-carbon material can be determined by means of a conventional test method in the art, for example scanning electron microscope (SEM) combined with an energy dispersive spectrometer (EDS), specifically, the cross sections of at least 10 silicon carbon particles are selected, the content of elemental silicon on the cross sections of each particle is tested and averaged.

In the present disclosure, the mass content of the silicon-based material in the negative electrode active coating layer is 1%-70%, for example 1%, 5%, 10%, 15%, 20%, 25%, 30%, 35%, 40%, 45%, 50%, 55%, 60%, 65% or 70%.

In the present disclosure, the thickness h1 of the first adhesive tape may be 5 μm-30 μm, for example 5 μm, 10 μm, 15 μm, 20 μm, 25 μm or 30 μm. The thickness h2 of the second adhesive tape may be 5 μm-30 μm, for example 5 μm, 10 μm, 15 μm, 20 μm, 25 μm or 30 μm.

In an embodiment, the thickness h1 of the first adhesive tape is 10 μm-20 μm. The thickness h2 of the second adhesive tape is 10 μm-20 μm.

In the present disclosure, the thickness h1 of the first adhesive tape and the thickness h2 of the second adhesive tape can be determined by means of a conventional test method in the art, for example 10 points are randomly selected on the first adhesive tape/second adhesive tape, and the thickness at each point is tested and averaged.

In the present disclosure, the shortest distance from the edge of the positive electrode tab to the edge of the arcuate region may be 0-6 mm, for example 0 mm, 1 mm, 2 mm, 3 mm, 4 mm, 5 mm or 6 mm. The shortest distance from the edge of the negative electrode tab to the edge of the arcuate region may be 0-6 mm, for example 0 mm, 1 mm, 2 mm, 3 mm, 4 mm, 5 mm or 6 mm.

In the present disclosure, the materials of the first and second adhesive tapes are not limited and can be adhesive tapes conventionally used in the art, for example acrylic adhesive tapes, rubber-type adhesive tapes, etc.

In the present disclosure, the size of the first end of the first adhesive tape beyond the first end of the positive electrode tab is denoted as d1, and the size of the second end of the first adhesive tape beyond the second end of the positive electrode tab is denoted as d2, which satisfy 1.5≤d1/d2≤8 (for example 1.5, 2, 3, 4, 5, 6, 7 or 8), wherein the first end is an end close to the arcuate region, and the second end is an end far from the arcuate region. The size of the first end of the second adhesive tape beyond the first end of the negative electrode tab is denoted as d3, and the size of the second end of the second adhesive tape beyond the second end of the negative electrode tab is denoted as d4, which satisfy 1.5≤d3/d4≤8 (for example 1.5, 2, 3, 4, 5, 6, 7 or 8), wherein the first end is an end close to the arcuate region, and the second end is an end far from the arcuate region.

In an embodiment, 3≤d1/d2≤6, and 3≤d3/d4≤6.

FIG. 3 is a cross-sectional schematic view of a jelly roll in an example of the present disclosure. As can be seen from the figure, the size of the first end of the first adhesive tape 7 beyond the first end of the positive electrode tab is denoted as d1, and the size of the second end of the first adhesive tape 7 beyond the second end of the positive electrode tab is denoted as d2; the size of the first end of the second adhesive tape 5 beyond the first end of the negative electrode tab is denoted as d3, and the size of the second end of the second adhesive tape 5 beyond the second end of the negative electrode tab is denoted as d4.

In the present disclosure, the size of the positive electrode tab in the length direction of the positive electrode plate may be 2 mm-20 mm, for example 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm or 20 mm. The thickness of the positive electrode tab may be 20 μm-100 μm, for example 20 μm, 30 μm, 40 μm, 50 μm, 60 μm, 70 μm, 80 μm, 90 μm or 100 μm. The size of the negative electrode tab in the length direction of the negative electrode plate may be 2 mm-20 mm, for example 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm or 20 mm. The thickness of the negative electrode tab may be 20 μm-100 μm, for example 20 μm, 30 μm, 40 μm, 50 μm, 60 μm, 70 μm, 80 μm, 90 μm or 100 μm.

In the present disclosure, the size of the first adhesive tape in the length direction of the positive electrode plate may be 4 mm-40 mm, for example 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 35 mm or 40 mm. The size of the second adhesive tape in the length direction of the negative electrode plate may be 4 mm-40 mm, for example 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 35 mm or 40 mm.

It will be understood that the means for increasing the thickness of the arcuate region is not limited in the present disclosure. For example, by adjusting the attachment position of the adhesive tapes on the positive and negative electrode plates, increasing the thickness of the positive electrode plate located in the arcuate region, increasing the thickness of the negative electrode plate located in the arcuate region, increasing the thickness of the separator located in the arcuate region, changing the manufacturing process to increase the thickness of the arcuate region, adjusting the sizes of the recesses and protrusions on the positive electrode plate, etc., the problems of cracking and lithium plating at the arcuate region can be improved, and will not be described again here.

In the present disclosure, the positive electrode plate may comprise a positive electrode current collector and a positive electrode active coating layer on a surface of at least one side of the positive electrode current collector. The positive electrode active coating layer may comprise a positive electrode active material. The positive electrode active material may include active materials conventionally used in the art, for example at least one of lithium a cobalt oxide, a lithium nickel oxide, a lithium manganese oxide, a lithium nickel cobalt oxide, a lithium manganese cobalt oxide, a lithium nickel manganese oxide, a lithium nickel cobalt manganese oxide, a lithium nickel cobalt aluminum oxide, lithium iron phosphate, a composite material of lithium iron phosphate and carbon, lithium manganese phosphate, a composite material of lithium manganese phosphate and carbon, lithium manganese iron phosphate, and a composite material of lithium manganese iron phosphate and carbon. The positive electrode active coating layer may further comprise a positive electrode conductive agent and a positive electrode binder. The positive electrode conductive agent includes, for example, at least one of superconductive carbon, acetylene black, carbon black, carbon dots, carbon nanotubes, graphene, and carbon nanofibers. The positive electrode binder may include binders conventionally used in the art, for example at least one of polyvinylidene fluoride, styrene butadiene rubber and an aluminate coupling agent.

In the present disclosure, the positive electrode plate has a first surface and a second surface arranged opposite to each other in the thickness direction. The first surface may have several recesses and the second surface may have several protrusions. The expression “several” means that the number of the recesses on the first surface is 2 or more and the number of the protrusions on the second surface is 2 or more.

In an embodiment, the positions of the recesses at the first surface correspond to the positions of the protrusions at the second surface.

In the present disclosure, the width of the recesses may be 0.2 mm-8 mm, for example 0.2 mm, 0.5 mm, 1 mm, 2 mm, 3 mm, 4 mm, 5 mm, 6 mm, 7 mm or 8 mm. The depth of the recesses may be 3 μm-40 μm, for example 3 μm, 5 μm, 10 μm, 15 μm, 20 μm, 25 μm, 30 μm, 35 μm or 40 μm. The spacing between the recesses may be 0.5 mm-8 mm, for example 0.5 mm, 1 mm, 2 mm, 3 mm, 4 mm, 5 mm, 6 mm, 7 mm or 8 mm.

In the present disclosure, the depth of the recesses refers to the perpendicular distance from the lowest point in the recesses to the surface of the positive electrode plate, which can be determined by means of a conventional test method in the art, for example scanning electron microscope (SEM) or 3D profiler, specifically, the depth of at least 20 recesses or all recesses on the surface of one side of the positive electrode plate is tested and averaged.

In the present disclosure, the shape of the projection of the recesses in the thickness direction of the positive electrode plate is not limited and can be circular or rectangular. When the shape of the projection of the recesses in the thickness direction of the positive electrode plate is circular, the width of the recesses is the diameter of the circle; and when the shape of the projection of the recesses in the thickness direction of the positive electrode plate is non-circular, the width of the recesses is the equivalent diameter of a circle with the same non-circular area. The width of the recesses and the spacing between the recesses can be determined by means of a conventional test method in the art, for example SEM, specifically, at least 10 recesses are selected on the surface of the positive electrode plate, and the width of each recess is tested and averaged. At least 10 groups of adjacent recesses are selected on the surface of the positive electrode plate, and the shortest distance between the edges of each group of recesses is tested and averaged.

In the present disclosure, the height of the protrusions may be 2 μm-40 μm, for example 2 μm, 5 μm, 10 μm, 15 μm, 20 μm, 25 μm, 30 μm, 35 μm or 40 μm. The width of the protrusions may be 0.2 mm-8 mm, for example 0.2 mm, 0.5 mm, 1 mm, 2 mm, 3 mm, 4 mm, 5 mm, 6 mm, 7 mm, or 8 mm. The spacing between the protrusions may be 0.5 mm-8 mm, for example 0.5 mm, 1 mm, 2 mm, 3 mm, 4 mm, 5 mm, 6 mm, 7 mm, or 8 mm.

In the present disclosure, the height of the protrusion refers to the perpendicular distance from the highest point on the protrusion to the surface of the positive electrode plate, which can be determined by means of a conventional test method in the art, for example SEM or a 3D profiler, specifically, the height of at least 20 protrusions or all protrusions on the surface of one side of the positive electrode plate is tested and averaged.

In the present disclosure, the shape of the projection of the protrusions in the thickness direction of the positive electrode plate is not limited and can be circular or rectangular. When the shape of the projection of the protrusions in the thickness direction of the positive electrode plate is circular, the width of the protrusions is the diameter of the circle; and when the shape of the projection of the protrusions in the thickness direction of the positive electrode plate is non-circular, the width of the protrusions is the equivalent diameter of a circle with the same non-circular area. The width of the protrusions and the spacing between the protrusions can be determined by means of a conventional test method in the art, for example SEM, specifically, at least 10 protrusions are selected on the surface of the positive electrode plate, and the width of each protrusion is tested and averaged. At least 10 groups of adjacent protrusions are selected on the surface of the positive electrode plate, and the shortest distance between the edges of each group of protrusions (that is, the shortest distance between orthogonal projections formed by each group of protrusions on the surface of the positive electrode plate) is tested and averaged.

In the present disclosure, the carbon-based material includes, for example, at least one of artificial graphite, natural graphite, mesocarbon microbeads, soft carbon and hard carbon. The negative electrode active coating layer may also comprise at least one of a lithium aluminum alloy, a tin-based negative electrode material, and a lithium transition metal oxide. The negative electrode active coating layer may further comprise a negative electrode conductive agent and a negative electrode binder. The negative electrode conductive agent may include conductive agents conventionally used in the art, for example at least one of superconductive carbon, acetylene black, carbon black, carbon dots, carbon nanotubes, graphene, and carbon nanofibers. The negative electrode binder may include binders conventionally used in the art, for example at least one of polyvinylidene fluoride, styrene butadiene rubber and an aluminate coupling agent.

In the present disclosure, the separator may include separators conventionally used in the art, for example at least one of polypropylene, polyethylene and polyvinylidene fluoride.

It should be noted that the digital representations such as “first” and “second” in the present disclosure are only used to distinguish different materials or usage modes and do not represent the difference in order.

The present disclosure will be described in detail below by means of examples. The examples described in the present disclosure are only some, rather than all, of the examples of the present disclosure. Based on the examples in the present disclosure, all other examples obtained by those of ordinary skill in the art without involving creative effort belong to the scope of protection of the present disclosure.

In the following examples, unless otherwise specified, all the materials used are commercially available and analytically pure.

The following examples are used to illustrate the lithium-ion secondary battery of the present disclosure.

### EXAMPLE 1

A lithium-ion secondary battery was prepared according to the following method:

### (1) Preparation of Positive Electrode Plate

Lithium cobaltate, carbon nanotubes and polyvinylidene fluoride were uniformly mixed in a mass ratio of 97.5:1.1:1.4, then N-methylpyrrolidone (NMP) was added, and the mixture was stirred thoroughly in a stirring tank to prepare a positive electrode slurry. The positive electrode slurry was uniformly transferred to the surface of a aluminum foil by means of an extrusion coating device, and baked in an oven at 80° C. for 10 min, and then wound with a reel after the solvent was completely removed. Then, the resulting electrode plate was unwound and rolled by a roller press with constant gap, wherein the compaction density of the arcuate region was equal to that of the straight region, the rolled electrode plate was cut by a cutting device in the TD direction according to the designed width size, and then processed by a special roller with protrusions to obtain a positive electrode plate with recesses on the surface of one side and protrusions on the surface of the other side, after the abnormality was detected and eliminated by a charge coupled device image sensor (CCD), the electrode plate was wound by a small-roll winding process. The positive electrode tab (the size of the positive electrode tab in the length direction of the positive electrode plate was 6 mm, the thickness of the positive electrode tab was 50 μm) was welded, and the first adhesive tape (an acrylic adhesive tape, the thickness h1 thereof was 15 μm) was attached. The resulting product was then cut to obtain a positive electrode plate.

The size of the first adhesive tape in the length direction of the positive electrode plate was 17 mm; d1/d2 was 4.3, the recesses had a width of 2 mm, a spacing of 2 mm and a depth of 15 μm; and the protrusions had a width of 2 mm, a spacing of 2 mm and a height of 14 μm.

### (2) Preparation of Negative Electrode Plate

Artificial graphite, a silicon-carbon material, carbon nanotubes and styrene-butadiene rubber were uniformly mixed in a mass ratio of 86.6:10.4:1.55:1.45, then deionized water was added, and the mixture was stirred thoroughly in a stirring tank to prepare a negative electrode slurry. The negative electrode slurry was transferred to the surface of a copper foil by means of an extrusion coating device, and baked in an oven at 120° C. for 5 min, and then wound with a reel after the solvent was completely removed. Then, the resulting electrode plate was unwound and rolled by a roller press with constant gap, wherein the compaction density of the arcuate region was equal to that of the straight region, the rolled electrode plate was cut by a cutting device in the TD direction according to the designed width size, after the abnormality was detected and eliminated by CCD, the electrode plate was wound by a small-roll winding process. The negative electrode tab (the size of the negative electrode tab in the length direction of the negative electrode plate was 6 mm, the thickness of the negative electrode tab was 50 μm) was welded, and the second adhesive tape (an acrylic adhesive tape, the thickness h2 thereof was 15 μm) was attached. The resulting product was then cut to obtain a negative electrode plate.

The size of the second adhesive tape in the length direction of the negative electrode plate was 17 mm; d3/d4 was 4.3; the content c of elemental silicon in the negative electrode active coating layer was 5.7%; c/h1 was 3.8×10⁻³, and c/h2 was 3.8×10⁻³.

### (3) Preparation of Electrolyte

In a glove box filled with argon (moisture<1 ppm, oxygen<1 ppm), a cyclic carbonate solvent (ethylene carbonate), a linear carbonate solvent (dimethyl carbonate) and a carboxylate solvent (ethyl propionate) were mixed to form a homogeneous organic solvent, then a lithium salt (lithium hexafluorophosphate), FEC, PS and additives (DTD and (SN+HTCN) in a mass ratio of 1:1) were slowly added thereto, and the mixture was stirred until uniform to obtain an electrolyte.

The mass content c1 of FEC in the electrolyte was 12%, the mass content c2 of PS in the electrolyte was 2.5%, the mass content c3 of the lithium salt in the electrolyte was 13%, the mass content of the cyclic carbonate solvent in the electrolyte was 17%, the mass content of the linear carbonate solvent in the electrolyte was 45% (c4 was 62%), the mass content c5 of the carboxylate solvent in the electrolyte was 5%, and the mass content of the additives in the electrolyte was 5.5%. The viscosity V of the electrolyte was 5.3 Pa·s; and c1/c2 was 4.8.

### (4) Preparation of Battery

The positive electrode plate prepared in step (1), the separator (oil-based 5+2+2 separator (5 μm thick base film+2 μm thick ceramic layer+2 μm thick polyvinylidene fluoride adhesive layer)) and the negative electrode plate prepared in step (2) were aligned at the head and then wound into a roll-like structure at a uniform speed according to the designed sizes. After winding, the shortest distance from the edge of the positive electrode tab to the edge of the arcuate region was 3 mm, and the shortest distance from the edge of the negative electrode tab to the edge of the arcuate region was 3 mm. Both the first and second adhesive tapes cover portion of the arcuate region, and the size of the portion of the arcuate region covered by the first adhesive tape was 38% of the arc length of the arc, and the size of the portion of the arcuate region covered by the second adhesive tape was 38% of the arc length of the arc. The electrolyte prepared in step (3) was added. After hot pressing, X-Ray or computed tomography was used to observe and measure the radius R of the arcuate region and the thickness T of the jelly roll. The product was aged at ambient temperature (25° C.) for 24 h, at elevated temperature (65° C.) for 8 h, so that the electrolyte can be fully infiltrated. The product was transferred to a formation equipment, and the positive and negative electrode tabs were connected to the charging port. The battery was charged and pressurized at a temperature of 80° C. and a pressure of 510 kgf/battery to activate the cell, so as to form a lithium-ion secondary battery that can be externally charged and discharged.

The radius R of the arcuate region was 5.31 mm and the thickness T of the jelly roll was 10.2 mm, 2R/T was 1.041;

$$\frac{2 R}{T \times ( c 1 + c 2 )} was 7.18 ; \frac{2 R}{T} \times c 3 was 0.135 ; and \frac{2 R}{T \times V} was 0.2 .$$

### EXAMPLE 2

A lithium-ion secondary battery was prepared according to the following method:

### (1) Preparation of Positive Electrode Plate

Lithium cobaltate, carbon nanotubes and polyvinylidene fluoride were uniformly mixed in a mass ratio of 97.5:1.1:1.4, then N-methylpyrrolidone (NMP) was added, and the mixture was stirred thoroughly in a stirring tank to prepare a positive electrode slurry. The positive electrode slurry was uniformly transferred to the surface of a aluminum foil by means of an extrusion coating device, and baked in an oven at 80° C. for 10 min, and then wound with a reel after the solvent was completely removed. Then, the resulting electrode plate was unwound and rolled by a roller press with constant gap, wherein the compaction density of the arcuate region was equal to that of the straight region, the rolled electrode plate was cut by a cutting device in the TD direction according to the designed width size, and then processed by a special roller with protrusions to obtain a positive electrode plate with recesses on the surface of one side and protrusions on the surface of the other side, after the abnormality was detected and eliminated by CCD, the electrode plate was wound by a small-roll winding process. The positive electrode tab (the size of the positive electrode tab in the length direction of the positive electrode plate was 4 mm, the thickness of the positive electrode tab was 60 μm) was welded, and the first adhesive tape (an acrylic adhesive tape, the thickness h1 thereof was 10 μm) was attached. The resulting product was then cut to obtain a positive electrode plate.

The size of the first adhesive tape in the length direction of the positive electrode plate was 14 mm; d1/d2 was 3.1, the recesses had a width of 2.5 mm, a spacing of 4 mm and a depth of 5 μm; and the protrusions had a width of 2.4 mm, a spacing of 4 mm and a height of 4 μm.

### (2) Preparation of Negative Electrode Plate

Artificial graphite, silicon-carbon material, carbon nanotubes and styrene-butadiene rubber were uniformly mixed in a mass ratio of 91.9:5.1:1.55:1.45, then deionized water was added, and the mixture was stirred thoroughly in a stirring tank to prepare a negative electrode slurry. The negative electrode slurry was transferred to the surface of a copper foil by means of an extrusion coating device, and baked in an oven at 120° C. for 5 min, and then wound with a reel after the solvent was completely removed. Then, the resulting electrode plate was unwound and rolled by a roller press with constant gap, wherein the compaction density of the arcuate region was equal to that of the straight region, the rolled electrode plate was cut by a cutting device in the TD direction according to the designed width size, after the abnormality was detected and eliminated by CCD, the electrode plate was wound by a small-roll winding process. The negative electrode tab (the size of the negative electrode tab in the length direction of the negative electrode plate was 4 mm, the thickness of the negative electrode tab was 60 μm) was welded, and the second adhesive tape (an acrylic adhesive tape, the thickness h2 thereof was 10 μm) was attached. The resulting product was then cut to obtain a negative electrode plate.

The size of the second adhesive tape in the length direction of the negative electrode plate was 14 mm; d3/d4 was 3.1; the content c of elemental silicon in the negative electrode active coating layer was 2.8%; c/h1 was 2.8×10⁻³, and c/h2 was 2.8×10⁻³.

### (3) Preparation of Electrolyte

In a glove box filled with argon (moisture<1 ppm, oxygen<1 ppm), a cyclic carbonate solvent (ethylene carbonate), a linear carbonate solvent (dimethyl carbonate) and a carboxylate solvent (ethyl propionate) were mixed to form a homogeneous organic solvent, then a lithium salt (lithium hexafluorophosphate), FEC, PS and additives (DTD and (SN+HTCN) in a mass ratio of 1:1) were slowly added thereto, and the mixture was stirred until uniform to obtain an electrolyte.

The mass content c1 of FEC in the electrolyte was 10%, the mass content c2 of PS in the electrolyte was 3%, the mass content c3 of the lithium salt in the electrolyte was 10%, the mass content of the cyclic carbonate solvent in the electrolyte was 15%, the mass content of the linear carbonate solvent in the electrolyte was 50% (c4 was 65%), the mass content c5 of the carboxylate solvent in the electrolyte was 6%, and the mass content of the additives in the electrolyte was 6%. The viscosity V of the electrolyte was 6 Pas; and c1/c2 was 3.33.

### (4) Preparation of Battery

The positive electrode plate prepared in step (1), the separator (oil-based 5+2+2 separator (5 μm thick base film+2 μm thick ceramic layer+2 μm thick polyvinylidene fluoride adhesive layer)) and the negative electrode plate prepared in step (2) were aligned at the head and then wound into a roll-like structure at a uniform speed according to the designed sizes. After winding, the shortest distance from the edge of the positive electrode tab to the edge of the arcuate region was 1 mm, and the shortest distance from the edge of the negative electrode tab to the edge of the arcuate region was 1 mm. Both the first and second adhesive tapes cover portion of the arcuate region, and the size of the portion of the arcuate region covered by the first adhesive tape was 21% of the arc length of the arc, and the size of the portion of the arcuate region covered by the second adhesive tape was 21% of the arc length of the arc. The electrolyte prepared in step (3) was added. After hot pressing, X-Ray or computed tomography was used to observe and measure the radius R of the arcuate region and the thickness T of the jelly roll. The product was aged at ambient temperature (25° C.) for 24 h, at elevated temperature (65° C.) for 8 h, so that the electrolyte can be fully infiltrated. The product was transferred to a formation equipment, and the positive and negative electrode tabs were connected to the charging port. The battery was charged and pressurized at a temperature of 80° C. and a pressure of 510 kgf/battery to activate the cell, so as to form a lithium-ion secondary battery that can be externally charged and discharged.

The radius R of the arcuate region was 2.72 mm and the thickness T of the jelly roll was 5.5 mm, 2R/T was 0.989;

$$\frac{2 R}{T \times ( c 1 + c 2 )} was 7.61 ; \frac{2 R}{T} \times c 3 was 0.099 ; and \frac{2 R}{T \times V} was 0.16 .$$

### EXAMPLE 3

A lithium-ion secondary battery was prepared according to the following method:

### (1) Preparation of Positive Electrode Plate

Lithium cobaltate, carbon nanotubes and polyvinylidene fluoride were uniformly mixed in a mass ratio of 97.5:1.1:1.4, then N-methylpyrrolidone (NMP) was added, and the mixture was stirred thoroughly in a stirring tank to prepare a positive electrode slurry. The positive electrode slurry was uniformly transferred to the surface of a aluminum foil by means of an extrusion coating device, and baked in an oven at 80° C. for 10 min, and then wound with a reel after the solvent was completely removed. Then, the resulting electrode plate was unwound and rolled by a roller press with constant gap, wherein the compaction density of the arcuate region was equal to that of the straight region, the rolled electrode plate was cut by a cutting device in the TD direction according to the designed width size, and then processed by a special roller with protrusions to obtain a positive electrode plate with recesses on the surface of one side and protrusions on the surface of the other side, after the abnormality was detected and eliminated by CCD, the electrode plate was wound by a small-roll winding process. The positive electrode tab (the size of the positive electrode tab in the length direction of the positive electrode plate was 8 mm, the thickness of the positive electrode tab was 70 μm) was welded, and the first adhesive tape (an acrylic adhesive tape, the thickness h1 thereof was 20 μm) was attached. The resulting product was then cut to obtain a positive electrode plate.

The size of the first adhesive tape in the length direction of the positive electrode plate was 20 mm; d1/d2 was 5.8, the recesses had a width of 0.2 mm, a spacing of 1 mm and a depth of 30 μm; and the protrusions had a width of 0.2 mm, a spacing of 1 mm and a height of 28 μm.

### (2) Preparation of Negative Electrode Plate

Artificial graphite, silicon-carbon material, carbon nanotubes and styrene-butadiene rubber were uniformly mixed in a mass ratio of 84.5:12.5:1.55:1.45, then deionized water was added, and the mixture was stirred thoroughly in a stirring tank to prepare a negative electrode slurry. The negative electrode slurry was transferred to the surface of a copper foil by means of an extrusion coating device, and baked in an oven at 120° C. for 5 min, and then wound with a reel after the solvent was completely removed. Then, the resulting electrode plate was unwound and rolled by a roller press with constant gap, wherein the compaction density of the arcuate region was equal to that of the straight region, the rolled electrode plate was cut by a cutting device in the TD direction according to the designed width size, after the abnormality was detected and eliminated by CCD, the electrode plate was wound by a small-roll winding process. The negative electrode tab (the size of the negative electrode tab in the length direction of the negative electrode plate was 8 mm, the thickness of the negative electrode tab was 70 μm) was welded, and the second adhesive tape (an acrylic adhesive tape, the thickness h2 thereof was 20 μm) was attached. The resulting product was then cut to obtain a negative electrode plate.

The size of the second adhesive tape in the length direction of the negative electrode plate was 20 mm; d3/d4 was 5.8; the content c of elemental silicon in the negative electrode active coating layer was 6.9%; c/h1 was 3.45×10⁻³, and c/h2 was 3.45×10⁻³.

### (3) Preparation of Electrolyte

In a glove box filled with argon (moisture<1 ppm, oxygen<1 ppm), a cyclic carbonate solvent (ethylene carbonate), a linear carbonate solvent (dimethyl carbonate) and a carboxylate solvent (ethyl propionate) were mixed to form a homogeneous organic solvent, then a lithium salt (lithium hexafluorophosphate), FEC, PS and additives (DTD and (SN+HTCN) in a mass ratio of 1:1) were slowly added thereto, and the mixture was stirred until uniform to obtain an electrolyte.

The mass content c1 of FEC in the electrolyte was 15%, the mass content c2 of PS in the electrolyte was 2%, the mass content c3 of the lithium salt in the electrolyte was 15%, the mass content of the cyclic carbonate solvent in the electrolyte was 20%, the mass content of the linear carbonate solvent in the electrolyte was 40% (c5 was 60%), the mass content c5 of the carboxylate solvent in the electrolyte was 4%, and the mass content of the additives in the electrolyte was 4%. The viscosity V of the electrolyte was 4.4 Pa·s; and c1/c2 was 7.5.

### (4) Preparation of Battery

The positive electrode plate prepared in step (1), the separator (oil-based 5+2+2 separator (5 μm thick base film+2 μm thick ceramic layer+2 μm thick polyvinylidene fluoride adhesive layer)) and the negative electrode plate prepared in step (2) were aligned at the head and then wound into a roll-like structure at a uniform speed according to the designed sizes by means of a winding equipment. After winding, the shortest distance from the edge of the positive electrode tab to the edge of the arcuate region was 6 mm, and the shortest distance from the edge of the negative electrode tab to the edge of the arcuate region was 6 mm. Both the first and second adhesive tapes cover portion of the arcuate region, and the size of the portion of the arcuate region covered by the first adhesive tape was 25% of the arc length of the arc, and the size of the portion of the arcuate region covered by the second adhesive tape was 25% of the arc length of the arc. The electrolyte prepared in step (3) was added. After hot pressing, X-Ray or computed tomography was used to observe and measure the radius R of the arcuate region and the thickness T of the jelly roll. The product was aged at ambient temperature (25° C.) for 24 h, at elevated temperature (65° C.) for 8 h, so that the electrolyte can be fully infiltrated. The product was transferred to a formation equipment, and the positive and negative electrode tabs were connected to the charging port. The battery was charged and pressurized at a temperature of 80° C. and a pressure of 510 kgf/battery to activate the cell, so as to form a lithium-ion secondary battery that can be externally charged and discharged.

The radius R of the arcuate region was 9.84 mm and the thickness T of the jelly roll was 17.5 mm, 2R/T, was 1.125;

$$\frac{2 R}{T \times ( c 1 + c 2 )} was 6.62 ; \frac{2 R}{T} \times c 3 was 0.169 ; and \frac{2 R}{T \times V} was 0.26 .$$

### Example 4 Group

This group of examples was used to verify the influence of the change of “2R/T”>

This group of examples was carried out with reference to Example 1, except that R was adjusted by changing the parameters of the winding equipment, so as to adjust and control 2R/T, specifically as follows.

In Example 4a, R was 4.78 mm, 2R/T was 0.937;

$$\frac{2 R}{T \times ( c 1 + c 2 )} was 6.46 ; \frac{2 R}{T} \times c 3 was 0.122 ; and \frac{2 R}{T \times V} was 0.18 .$$

In Example 4b, R was 6.2 mm, 2R/T was 1.216;

$$\frac{2 R}{T \times ( c 1 + c 2 )} was 8.38 ; \frac{2 R}{T} \times c 3 was 0.158 ; and \frac{2 R}{T \times V} was 0.23 .$$

### Example 5 Group

This group of examples was used to verify the influence of the change of

$$“ \frac{2 R}{T \times ( c 1 + c 2 )} ”$$

This group of examples was carried out with reference to Examples 2 and 3, respectively, except that

$$\frac{2 R}{T \times ( c 1 + c 2 )}$$

was adjusted and controlled by changing the mass content c1 of FEC in the electrolyte and the mass content c2 of PS in the electrolyte, specifically as follows.

Example 5a was carried out with reference to Example 2, except that the electrolyte was replaced with the electrolyte prepared in Example 3; and

$$\frac{2 R}{T \times ( c 1 + c 2 )} was 5.82 .$$

Example 5b was carried out with reference to Example 3, except that the electrolyte was replaced with the electrolyte prepared in Example 2; and

$$\frac{2 R}{T \times ( c 1 + c 2 )} was 8.65 .$$

### Example 6 Group

This group of examples was used to verify the influence of the change of “the mass content c1 of FEC in the electrolyte”.

This group of examples was carried out with reference to Example 1, except that c1 was changed, and in order to ensure that the viscosity V of the electrolyte was basically unchanged, the composition of the electrolyte was specifically as follows.

In Example 6a, c1 was 4%, c2 was 2.5%, c1/c2 was 1.6, c3 was 13%, c4 was 65.6% (wherein the mass content of the cyclic carbonate was 23.3% and the mass content of the linear carbonate was 42.3%), c5 was 7.4%, the mass content of the additives in the electrolyte was 7.5%; and

$$\frac{2 R}{T \times ( c 1 + c 2 )} was 16.02 .$$

In Example 6b, c1 was 20%, c2 was 2.5%, c1/c2 was 8, c3 was 13%, c4 was 55.5% (wherein the mass content of the cyclic carbonate was 18.4% and the mass content of the linear carbonate was 37.1%), c5 was 4.1%, the mass content of the additives in the electrolyte was 4.9%; and

$$\frac{2 R}{T \times ( c 1 + c 2 )} was 4.63 .$$

### Example 7 Group

This group of examples was used to verify the influence of the change of “the mass content c2 of PS in the electrolyte”.

This group of examples was carried out with reference to Example 1, except that c2 was changed, and in order to ensure that the viscosity V of the electrolyte was basically unchanged, the composition of the electrolyte was specifically as follows.

In Example 7a, c1 was 12%, c2 was 1%, c1/c2 was 12, c3 was 13%, c4 was 63.5% (wherein the mass content of the cyclic carbonate was 18.2% and the mass content of the linear carbonate was 45.3%), c5 was 5%, and the mass content of the additives in the electrolyte was 5.5%.

In Example 7b, c1 was 12%, c2 was 5%, c1/c2 was 2.4, c3 was 13%, c4 was 61.5% (wherein the mass content of the cyclic carbonate was 18.2% and the mass content of the linear carbonate was 43.3%), c5 was 4%, and the mass content of the additives in the electrolyte was 4.5%.

### Example 8 Group

This group of examples was used to verify the influence of the change of “the mass content c3 of the lithium salt in the electrolyte”.

This group of examples was carried out with reference to Example 1, except that c3 was changed, and in order to ensure that the viscosity V of the electrolyte was basically unchanged, the composition of the electrolyte was specifically as follows.

In Example 8a, c1 was 12%, c2 was 2.5%, c3 was 7%, c4 was 63.7% (wherein the mass content of the cyclic carbonate was 18.4% and the mass content of the linear carbonate was 45.3%), c5 was 8.3%, the mass content of the additives in the electrolyte was 6.5%; and

$$\frac{2 R}{T} \times c 3 was 0.073 .$$

In Example 8b, c1 was 12%, c2 was 2.5%, c3 was 20%, c4 was 58.6% (wherein the mass content of the cyclic carbonate was 24.5% and the mass content of the linear carbonate was 34.1%), c5 was 3.1%, the mass content of the additives in the electrolyte was 3.8%; and

$$\frac{2 R}{T} \times c 3 was 0.208 .$$

### Example 9 Group

This group of examples was used to verify the influence of the change of “the viscosity V of the electrolyte”.

This group of examples was carried out with reference to Example 1, except that V was adjusted and controlled by changing the mass content of some materials in the electrolyte, and the composition of the electrolyte was specifically as follows.

In Example 9a, c1 was 12%, c2 was 2.5%, c3 was 13%, c4 was 62% (wherein the mass content of the cyclic carbonate was 27.4% and the mass content of the linear carbonate was 34.6%), c5 was 5%, the mass content of the additives in the electrolyte was 5.5%; V was 3 Pa·s, and

$$\frac{2 R}{T \times V} was 0.35 .$$

In Example 9b, c1 was 12%, c2 was 2.5%, c3 was 13%, c4 was 61.4% (wherein the mass content of the cyclic carbonate was 13.2% and the mass content of the linear carbonate was 48.2%), c5 was 5.3%, the mass content of the additives in the electrolyte was 5.8%; V was 9.9 Pa·s, and

$$\frac{2 R}{T \times V} was 0.1 .$$

### Example 10 Group

This group of examples was used to verify the influence of the change of “the proportion of the size of the portion of the arcuate region covered by the first adhesive tape to the arc length of the arc”.

This group of examples was carried out with reference to Example 1, except that the proportion of the size of the portion of the arcuate region covered by the first adhesive tape to the arc length of the arc was adjusted and controlled by changing the attachment position of the first adhesive tape, specifically as follows.

In Example 10a, the size of the portion of the arcuate region covered by the first adhesive tape was 10% of the arc length of the arc, and the size of the first adhesive tape in the length direction of the positive electrode plate was 16 mm; and the radius R of the arcuate region on the side of positive electrode tab was 5.22 mm.

In Example 10b, the size of the portion of the arcuate region covered by the first adhesive tape was 50% of the arc length of the arc, and the size of the first adhesive tape in the length direction of the positive electrode plate was 20 mm; and the radius R of the arcuate region on the side of positive electrode tab was 5.35 mm.

### Example 11 Group

This group of examples was used to verify the influence of the change of “the thickness h1 of the first adhesive tape”.

This group of examples was carried out with reference to Example 1, except that h1 was changed, specifically as follows.

In Example 11a, h1 was 5 μm; the radius R of the arcuate region on the side of positive electrode tab was 4.9 mm, and the thickness T of the jelly roll was unchanged.

In Example 11b, h1 was 30 μm; the radius R of the arcuate region on the side of positive electrode tab was 5.8 mm, and the thickness T of the jelly roll was unchanged.

### Example 12 Group

This group of examples was used to verify the influence of the change of “c/h1 and c/h2”.

This group of examples was carried out with reference to Examples 2 and 3, respectively, except that c/h1 and c/h2 were adjusted and controlled by changing c, specifically as follows.

Example 12a was carried out with reference to Example 2, except that artificial graphite, silicon-carbon material, carbon nanotubes and styrene-butadiene rubber were uniformly mixed in a mass ratio of 84.5:12.5:1.55:1.45; c was 6.9%, c/h1 was 6.9×10⁻³, and c/h2 was 6.9×10⁻³.

Example 12b was carried out with reference to Example 3, except that artificial graphite, silicon-carbon material, carbon nanotubes and styrene-butadiene rubber were uniformly mixed in a mass ratio of 91.9:5.1:1.55:1.45; c was 2.8%, c/h1 was 1.4×10⁻³, and c/h2 was 1.4×10⁻³.

### Example 13 Group

This group of examples was used to verify the influence of the change of “the proportion of the size of the portion of the arcuate region covered by the second adhesive tape to the arc length of the arc”.

This group of examples was carried out with reference to Example 1, except that the proportion of the size of the portion of the arcuate region covered by the second adhesive tape to the arc length of the arc was adjusted and controlled by changing the attachment position of the second adhesive tape, specifically as follows.

In Example 13a, the size of the portion of the arcuate region covered by the second adhesive tape was 10% of the arc length of the arc, and the size of the second adhesive tape in the length direction of the negative electrode plate was 16 mm; and the radius R of the arcuate region on the side of negative electrode tab was 5.22 mm.

In Example 13b, the size of the portion of the arcuate region covered by the second adhesive tape was 50% of the arc length of the arc, and the size of the second adhesive tape in the length direction of the negative electrode plate was 20 mm; and the radius R of the arcuate region on the side of negative electrode tab was 5.35 mm.

### Example 14 Group

This group of examples was used to verify the influence of the change of “the thickness h2 of the second adhesive tape”.

This group of examples was carried out with reference to Example 1, except that h2 was changed, specifically as follows.

In Example 14a, h2 was 5 μm; the radius R of the arcuate region on the side of negative electrode tab was 4.9 mm, and the thickness T of the jelly roll was unchanged.

In Example 14b, h2 was 30 μm; the radius R of the arcuate region on the side of negative electrode tab was 5.8 mm, and the thickness T of the jelly roll was unchanged.

### EXAMPLE 15

This example was used to verify the influence of the change of “the content c of elemental silicon in the negative electrode active coating layer”.

This example was carried out with reference to Example 1, except that c was adjusted and controlled by changing the content of materials in the negative electrode slurry, specifically as follows. Artificial graphite, silicon-carbon material, carbon nanotubes and styrene-butadiene rubber were uniformly mixed in a mass ratio of 95.2:1.8:1.55:1.45; c was 1%; c/h1 was 6.67×10⁻⁴, and c/h2 was 6.67×10⁻⁴.

### Comparative Example 1 Group

This group of comparative examples was used to verify the influence of the change of “2R/T”.

This group of comparative examples was carried out with reference to Example 1, except that R was adjusted by changing the parameters of the winding equipment, so as to adjust and control 2R/T, specifically as follows.

In Comparative Example 1a, R was 4.55 mm, and 2R/T was 0.892.

In Comparative Example 1b, R was 6.55 mm, and 2R/T was 1.284.

### Comparative Example 2 Group

This group of comparative examples was used to verify the influence of the change of “the mass content c1 of FEC in the electrolyte”.

This group of comparative examples was carried out with reference to Example 1, except that, c1 was changed, and in order to ensure that the viscosity V of the electrolyte was basically unchanged, the composition of the electrolyte was specifically as follows.

In Comparative Example 2a, c1 was 0%, c2 was 2.5%, c3 was 13%, c4 was 69.6% (wherein the mass content of the cyclic carbonate was 23.3% and the mass content of the linear carbonate was 46.3%), c5 was 7.4%, and the mass content of the additives in the electrolyte was 7.5%.

In Comparative Example 2b, c1 was 25%, c2 was 2.5%, c3 was 13%, c4 was 50.5% (wherein the mass content of the cyclic carbonate was 13.4% and the mass content of the linear carbonate was 37.1%), c5 was 4.1%, and the mass content of the additives in the electrolyte was 4.9%.

### Comparative Example 3 Group

This group of comparative examples was used to verify the influence of the change of “the mass content c2 of PS in the electrolyte”.

This group of comparative examples was carried out with reference to Example 1, except that, c2 was changed, and in order to ensure that the viscosity V of the electrolyte was basically unchanged, the composition of the electrolyte was specifically as follows.

In Comparative Example 3a, c1 was 12%, c2 was 0%, c3 was 13%, c4 was 63.5% (wherein the mass content of the cyclic carbonate was 17.8% and the mass content of the linear carbonate was 45.7%), c5 was 4.7%, and the mass content of the additives in the electrolyte was 6.8%.

In Comparative Example 3b, c1 was 12%, c2 was 7%, c3 was 13%, c4 was 59.5% (wherein the mass content of the cyclic carbonate was 17.2% and the mass content of the linear carbonate was 42.3%), c5 was 4%, and the mass content of the additives in the electrolyte was 4.5%.

### Cycling Test

The batteries prepared in examples and comparative examples were subjected to a cycling test, and the specific test method was as follows.

2C step charging system was used, in which the upper limit voltage was 4.45 V, the charge cutoff rate was 0.05 C, and the battery was discharged to 3 V at a constant current of 0.7 C. The initial capacity and initial full-charge thickness of the battery were measured, in which the thickness was determined by PPG test. During cycling of the battery, the thickness expansion was recorded every 100 T (the full-charge thickness after cycling minus the initial full-charge thickness), and the cycle was 800 T. The cycling capacity retention rate and thickness expansion rate were recorded in Table 1. Then the battery was disassembled, and the situations of cracking and lithium plating at the arcuate region were observed. The severity of cracking from light to heavy level was defined as: no cracking, slight cracking (the crack covered less than or equal to 40% of the width of the battery), severe cracking (the crack covered greater than 40% and smaller than or equal to 80% of the width of the battery), and complete cracking (the crack covered 100% of the width of the battery). The severity of lithium plating from light to heavy level was defined as: no lithium plating, slight lithium plating (lithium plating at the arcuate region covered less than or equal to 20% of the width of the battery), lithium plating (lithium plating at the arcuate region covered less than or equal to 50% of the width of the battery), and severe lithium plating (lithium plating at the arcuate region covered greater than or equal to 50% of the width of the battery). The results were recorded in Table 1.

TABLE 1

| | Capacity | Thickness | Situation of | Situation of lithium |
|---|---|---|---|---|
| | retention rate | expansion rate | cracking | plating |
| Example 1 | 93.20% | 10.50% | No cracking | No lithium plating |
| Example 2 | 92.10% | 11.70% | No cracking | No lithium plating |
| Example 3 | 88.20% | 13.30% | No cracking | No lithium plating |
| Example 4a | 85.30% | 14.30% | Slight cracking | No lithium plating |
| Example 4b | 87.70% | 14.10% | No cracking | Lithium plating |
| Example 5a | 84.9%% | 14.20% | Slight cracking | No lithium plating |
| Example 5b | 83.60% | 15.40% | Slight cracking | No lithium plating |
| Example 6a | 81.90% | 16.70% | Slight cracking | Severe lithium |
| | | | | plating |
| Example 6b | 81.30% | 17.10% | Slight cracking | Lithium plating |
| Example 7a | 82.30% | 18.10% | Slight cracking | Lithium plating |
| Example 7b | 81.90% | 14.40% | Slight cracking | Slight lithium |
| | | | | plating |
| Example 8a | 80.50% | 18.70% | Slight cracking | Lithium plating |
| Example 8b | 82.20% | 19.20% | No cracking | Lithium plating |
| Example 9a | 86.70% | 12.90% | No cracking | No lithium plating |
| Example 9b | 83.10% | 16.60% | Severe cracking | Severe lithium |
| | | | | plating |
| Example | 87.40% | 14.70% | Slight cracking | No lithium plating |
| 10a | | | | |
| Example | 91.20% | 13.10% | No cracking | Slight lithium |
| 10b | | | | plating |
| Example | 85.70% | 17.20% | Slight cracking | No lithium plating |
| 11a | | | | |
| Example | 87.30% | 14.70% | No cracking | Slight lithium |
| 11b | | | | plating |
| Example | 89.20% | 9.80% | No cracking | No lithium plating |
| 12a | | | | |
| Example | 84.20% | 15.90% | Slight cracking | No lithium plating |
| 12b | | | | |
| Example | 87.20% | 15.10% | Slight cracking | No lithium plating |
| 13a | | | | |
| Example | 87.90% | 14.40% | No cracking | Slight lithium |
| 13b | | | | plating |
| Example | 85.20% | 17.60% | Slight cracking | No lithium plating |
| 14a | | | | |
| Example | 86.80% | 14.50% | No cracking | Slight lithium |
| 14b | | | | plating |
| Example 15 | 91.70% | 9.20% | No cracking | No lithium plating |
| Comparative | 81.30% | 19.30% | Complete | Lithium plating |
| Example 1a | | | cracking | |
| Comparative | 80.70% | 18.50% | No cracking | Severe lithium |
| Example 1b | | | | plating |
| Comparative | 51.20% | 30.70% | Complete | Severe lithium |
| Example 2a | | | cracking | plating |
| Comparative | 75.80% | 24.10% | Complete | Severe lithium |
| Example 2b | | | cracking | plating |
| Comparative | 79.20% | 20.10% | Severe cracking | Severe lithium |
| Example 3a | | | | plating |
| Comparative | 85.80% | 17.30% | Severe cracking | Severe lithium |
| Example 3b | | | | plating |

As can be seen from Table 1, compared with the batteries in the comparative example, the battery of the present disclosure has excellent cycling stability and can effectively improve the problems of cracking and lithium plating at the arcuate region.

The preferred embodiments of the present disclosure have been described in detail above; however, the present disclosure is not limited thereto. Within the technical concept of the present disclosure, various simple modifications can be made to the technical solution of the present disclosure, including the combination of various technical features in any other suitable way. These simple modifications and combinations should also be regarded as the content disclosed by the present disclosure and all fall within the scope of protection of the present disclosure.

1. A lithium-ion secondary battery, wherein the lithium-ion secondary battery comprises a jelly roll formed by laminating and winding a positive electrode plate, a separator, and a negative electrode plate, wherein the negative electrode plate comprises a silicon-based material; the jelly roll has an arcuate region and a straight region connected to the arcuate region; and a radius R of the arcuate region and a thickness T of the jelly roll satisfy: 0.95≤2R/T≤4/π, where π is the ratio of circumference to diameter;
and wherein the lithium-ion secondary battery further comprises an electrolyte, and the electrolyte comprises fluoroethylene carbonate and 1,3-propane sultone; the mass content c1 of fluoroethylene carbonate in the electrolyte is 4%-20%, and the mass content c2 of 1,3-propane sultone in the electrolyte is 1%-5%.

2. The lithium-ion secondary battery according to claim 1, wherein c1, c2, R and T satisfy:
$$4 \leq \frac{2 R}{T \times ( c 1 + c 2 )} \leq 17 ;$$
and c1/c2 is 1-12.

3. The lithium-ion secondary battery according to claim 2, wherein
$$5.8 \leq \frac{2 R}{T \times ( c 1 + c 2 )} \leq 8.7 .$$

4. The lithium-ion secondary battery according to claim 3, wherein
$$6.6 \leq \frac{2 R}{T \times ( c 1 + c 2 )} \leq 7.7 .$$

5. The lithium-ion secondary battery according to claim 1, wherein the electrolyte further comprises a lithium salt, and the mass content c3 of the lithium salt in the electrolyte, R and T satisfy:
$$0.07 \leq \frac{2 R}{T} \times c 3 \leq 0.25 ;$$
and, c3 is 7%-25%.

6. The lithium-ion secondary battery according to claim 1, wherein the positive electrode plate has a first surface and a second surface arranged opposite to each other in the thickness direction; the first surface has several recesses and the second surface has several protrusions.

7. The lithium-ion secondary battery according to claim 6, wherein
the positions of the recesses at the first surface correspond to the positions of the protrusions at the second surface.

8. The lithium-ion secondary battery according to claim 6, wherein the width of the recesses is 0.2 mm-8 mm, the depth of the recesses is 3 μm-40 μm, and the spacing between the recesses is 0.5 mm-8 mm.

9. The lithium-ion secondary battery according to claim 1, wherein the electrolyte further comprises an organic solvent comprising a carbonate solvent and/or a carboxylate solvent.

10. The lithium-ion secondary battery according to claim 9, wherein
the mass content c4 of the carbonate solvent in the electrolyte is 10%-70%; and
the mass content c5 of the carboxylate solvent in the electrolyte is 3%-40%.

11. The lithium-ion secondary battery according to claim 1, wherein the positive electrode plate comprises a positive electrode tab located in a positive electrode tab welding zone and a first adhesive tape covering the positive electrode tab welding zone;
the negative electrode plate comprises a negative electrode tab located in a negative electrode tab welding zone and a second adhesive tape covering the negative electrode tab welding zone;
the first adhesive tape covers at least portion of the arcuate region, and the second adhesive tape covers at least portion of the arcuate region.

12. The lithium-ion secondary battery according to claim 11, wherein
the size of the portion of the arcuate region covered by the first adhesive tape is 10%-50% of the arc length of the arc; and
the size of the portion of the arcuate region covered by the second adhesive tape is 10%-50% of the arc length of the arc.

13. The lithium-ion secondary battery according to claim 11, wherein the negative electrode plate comprises a negative electrode current collector and a negative electrode active coating layer on a surface of at least one side of the negative electrode current collector, wherein the negative electrode active coating layer comprises a silicon-based material and a carbon-based material;
the content c of elemental silicon in the negative electrode active coating layer and the thickness h1 of the first adhesive tape, in μm, satisfy: 6×10⁻⁴≤c/h1≤2×10⁻²;
the content c of elemental silicon in the negative electrode active coating layer and the thickness h2 of the second adhesive tape, in μm, satisfy: 6×10⁻⁴≤c/h2≤2×10⁻²;
and, c is 1%-50.

14. The lithium-ion secondary battery according to claim 13, wherein
the silicon-based material comprises a silicon-carbon material comprising a porous carbon matrix and a silicon material located within internal pores of the porous carbon matrix.

15. The lithium-ion secondary battery according to claim 13, wherein the mass content of elemental silicon in the silicon-carbon material is 20%-70%.

16. The lithium-ion secondary battery according to claim 11, wherein the thickness h1 of the first adhesive tape is 5 μm-30 μm;
the thickness h2 of the second adhesive tape is 5 μm-30 μm;
the shortest distance from an edge of the positive electrode tab to an edge of the arcuate region is 0-6 mm;
and, the shortest distance from an edge of the negative electrode tab to the edge of the arcuate region is 0-6 mm.

17. The lithium-ion secondary battery according to claim 11, wherein the size of a first end of the first adhesive tape beyond the first end of the positive electrode tab is denoted as d1, and the size of a second end of the first adhesive tape beyond the second end of the positive electrode tab is denoted as d2, which satisfy 1.5≤d1/d2≤8, wherein the first end of the first adhesive tape is an end close to the arcuate region, and the second end of the first adhesive tape is an end far from the arcuate region;
and, the size of a first end of the second adhesive tape beyond the first end of the negative electrode tab is denoted as d3, and the size of a second end of the second adhesive tape beyond the second end of the negative electrode tab is denoted as d4, which satisfy 1.5≤d3/d4≤8, wherein the first end of the second adhesive tape is an end close to the arcuate region, and the second end of the second adhesive tape is an end far from the arcuate region.

18. The lithium-ion secondary battery according to claim 17, wherein 3≤d1/d2≤ 6 and 3≤d3/d4≤6.

19. The lithium-ion secondary battery according to claim 11, wherein the size of the positive electrode tab in the length direction of the positive electrode plate is 2 mm-20 mm, and the thickness of the positive electrode tab is 20 μm-100 μm;
the size of the negative electrode tab in the length direction of the negative electrode plate is 2 mm-20 mm, and the thickness of the negative electrode tab is 20 μm-100 μm;
the size of the first adhesive tape in the length direction of the positive electrode plate is 4 mm-40 mm;
and, the size of the second adhesive tape in the length direction of the negative electrode plate is 4 mm-40 mm.
